(19) United States
(12) Patent Application Publication
(10) Pub. No.: US 2006/0136977 A1
(43) Pub. Date: Jun. 22, 2006

(54) Select view television system

(76) Inventor: Averill Henry, Riverside, CA (US)

Correspondence Address: AVERILL HENRY, 5484 GREENBRIER DRIVE, RIVERSIDE, CA, 92504, US

(21) Appl. No.: 11/015,903

(22) Filed: Dec. 16, 2004

(51) Int. Cl. A63F 13/00; H04N 7/173; H04N 7/16; G06F 19/00; A63F 9/24; G06F 17/00

(52) U.S. Cl. 725/133; 725/141; 463/40

(57) ABSTRACT

The Select View Television System offers television viewers an alternative to the limitations of “standard” television by allowing sports, the Academy Awards, and other events to be viewed as if the viewers were actually attending the event. Upon initial activation, the invention displays a basic view typical to television viewers; however, when the multi-viewer feature of the invention is selected, system's remote control allows selection of a preferred camera view of the event. The invention can be utilized by advertisers to expose consumers to their products/services by posting their advertisement as a screen header/footer on one of the camera views for an event, by sports coaches as a means of viewing/critiquing players who are not playing in a game, by medical personnel to determine the event/movement causing injury to a player during a game, and by security personnel to resolve security issues arising during an event.

### BACKGROUND OF THE INVENTION

For years, sports enthusiasts have attended live sporting events where they have enjoyed all the action and excitement that takes place during a game. While they are in the arena, stadium, or other venue where an event is taking place, the sports enthusiast has the opportunity to watch all the action that takes place during the game such as the action on the sidelines, what is happening in the bullpen, what the fans are doing in the stands as well as the play being made on the field. In contrast, when the sport enthusiast has to watch a sporting event at home due to it being sold out or due to some other extenuating circumstance, he or she is limited by the existing systems in place that control the broadcasting of a sporting event. The sports enthusiast is essentially at the mercy of the television networks as far as how they are able to view and enjoy the sporting event they are watching. The television networks actually determine where the camera shots are being taken during the sporting event as well as what action is deemed worthy of showing on televised sporting events and other media.

The Select View Television System offers the television viewer a viable alternative to the limitations of “standard” television coverage by allowing events to be viewed at home as if he or she were actually attending the live event. When the Select View Television System is initially activated, it would display a basic view of an event typical to television viewers; however, when the multi-viewer feature of the Select View Television System is selected, the viewer can utilize the system's remote control to select their preferred camera view of the event. As a result, the viewer has the luxury of viewing any event broadcast on television as if they were actually at the event but in the comfort and convenience of their own home. In addition, the multi-camera view capability of the system could be utilized by security personnel to resolve security issues arising at special events, by sports coaches as a training tool for their players as well as by medical personnel to determine the event or movement that caused an injury to a player during a game.

### BRIEF SUMMARY OF THE INVENTION

The Select View Television System offers television viewers an alternative to the limitations of “standard” television coverage by allowing televised events such as sporting events, the American Music Awards, the Academy Awards, Presidential Debates, news conferences, parades and other televised special events to be viewed as if the viewers were actually attending the event. The invention also has a stand-alone top box with lighted, interchangeable faceplates that can be changed by the viewer to reflect the particular sporting event or theme they are viewing.

When the Select View Television System is initially activated, it displays a basic view typical to television viewers; however, when the multi-viewer feature of the Select View Television System is selected, the viewer can utilize the system's remote control to select their preferred camera view of the event. The invention also allows virtual viewing of computer-generated versions of multiple viewing angles of television, video, sports, or sitcom feeds that can be computer generated. The Select View Television System can also be utilized by advertisers to expose consumers to their products and services by posting their advertisement as a screen header/footer on each of the camera views for a specific event. The header or footer can be selected enabling the viewer access to professional sports and college property websites allowing the viewer to purchase licensed items through Select View Television. Finally, the Select View Television System can also be utilized by sports coaches of professional, high school, and college sports teams as a training tool since the system would give sport coaches the ability to view, analyze, and critique players who are away from the action on the field.

### DESCRIPTION OF DRAWINGS

FIG. 1 is a screen view of the Select View Television System showing a select view camera (SVC) with the identification of the camera in the lower left margin of the screen as shown, SVC 1. Therefore, each additional camera (not shown) will be identified by a different number to indicate to the viewer the camera view selected;

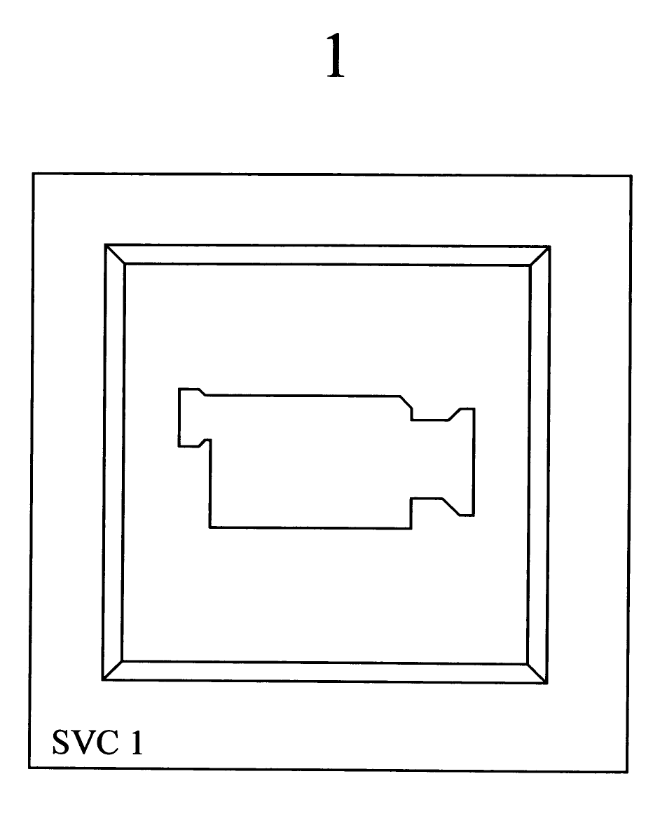

FIG. 2 is a screen view of the Select View Television System showing the local channel the sporting event is being broadcast on as well as the camera view of the sporting event that can be selected by the viewer;

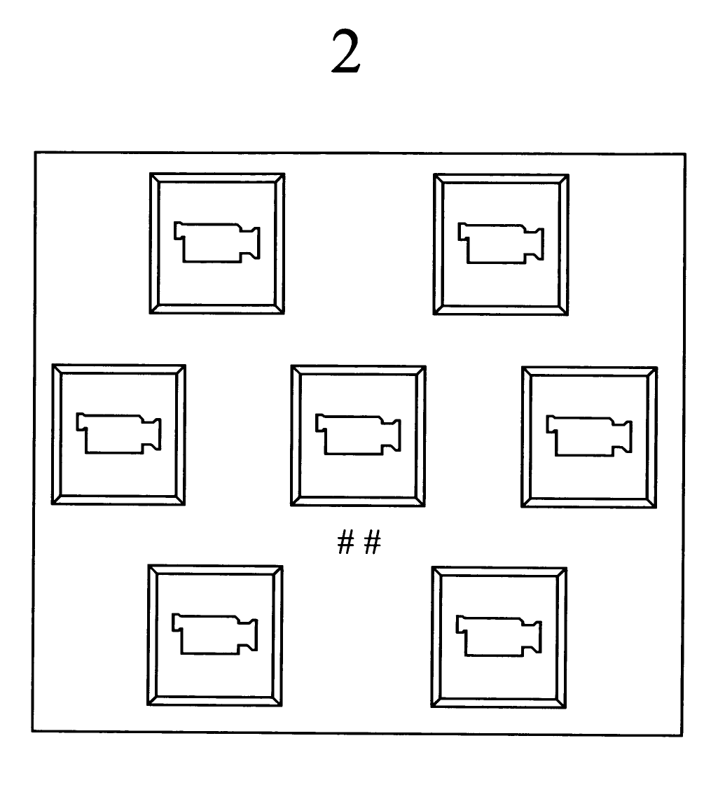

FIG. 3 is a top view of the Remote Control for the Select View Television System where A is the Button (Time Display), B is the Button (Return to Standard Feature View), C is the Button (Home Menu Screen), D is the Dial (16 Channel Selection Dial), E is the Button (Channel Selection Lock), F is the Button (Fast Forward), G is the Button (Fast Rewind), H is the Button (Digital Zoon/One Button Record), and J is the display, K is a Battery Terminal, L is a Battery Terminal;

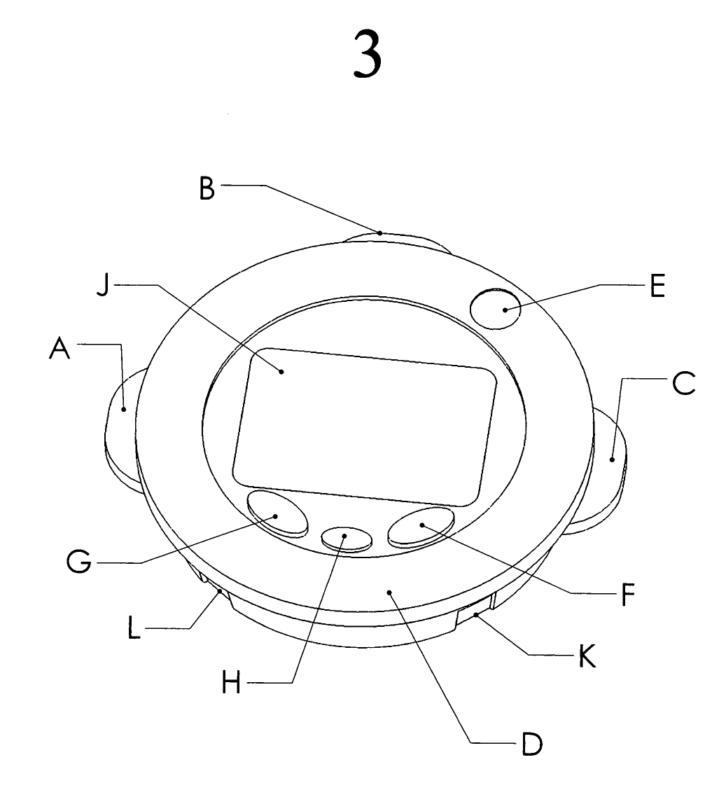

FIG. 4 is a view of the charge cradle for the Remote Control for the Select View Television System where A is the Electrode, B is the Electrode, C is the Arm Band Carriage, and D is the Remote Control Platform;

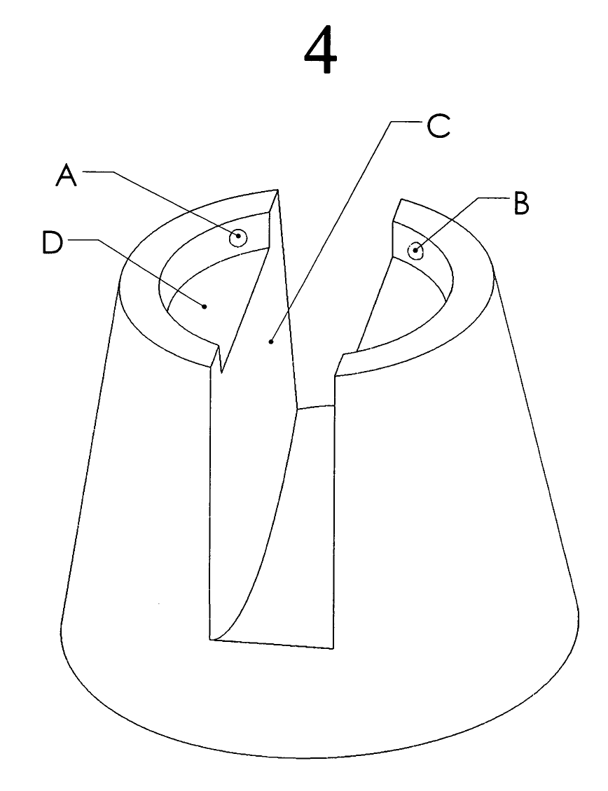

FIG. 5 is a view of the Remote Control (B) for the Select View Television System inserted into the charge cradle (A).

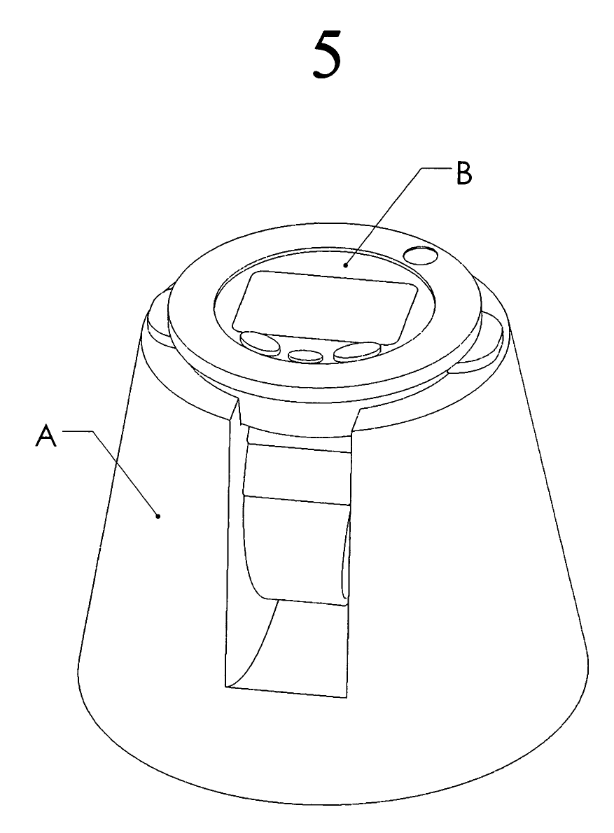

### DETAILED DESCRIPTION OF THE INVENTION

The Select View Television System offers television viewers an alternative to the limitations of “standard” television coverage by allowing televised events such as sporting events, the American Music Awards, the Academy Awards, Presidential Debates, news conferences, parades, and other televised special events to be viewed as if the viewers were actually attending the event. The invention can be utilized with systems including but not limited to analog, digital, satellite, UHF/VHF, shortwave, infrared, and other broadcasting systems or mediums. The Select View Television System also allows virtual viewing of computer-generated versions of multiple viewing angles of television, video, sports, or sitcom feeds that can be computer generated.

When the Select View Television System is initially activated, it displays a basic view typical to television viewers; however, when the multi-viewer feature of the Select View Television System is selected, the viewer can utilize the system's remote control to select their preferred camera view of the event. The viewer is afforded the ability of selecting from multiple views of the event they are viewing via the use of at least 2 alternative camera views that are broadcast via satellite on a single or multiple channel that when received by the recipient viewer's Select View Television System, will interpret the broadcast and allow the viewer to select their preferred camera view of the event via the remote control that the system is equipped with. The remote control that the Select View Television System is equipped with can be handheld, worn on the viewer's wrist, mounted, or used in any other fashion remotes are commonly operated while they are viewing the event on television. The remote for the Select View Television System is powered by power sources including but not limited to a rechargeable battery, alkaline batteries, solar power, cordless phone technology, infrared, and other means of providing power to the remote control. The Select View Television System can also be utilized by advertisers to expose consumers to their products and services by posting their advertisement as a screen header/footer on one of the camera views for a specific event. For example, a sponsor can pay for each camera view activated to provide the best coverage for an event. Then, consumer products (food, beverage, household products, etc.) and service companies (shipping, cleaning, telecommunications, etc.) can bid for the most popular camera view most accessed by viewers. In addition, professional sports properties can own the header or footer and can utilize the header or footer for their own advertising or promotional purposes. Advertisers who successfully bid on these camera views could then have their logo posted as a screen header or footer on the camera view they were awarded the bid for. Their logo in turn would be seen as viewers select camera views during the broadcast of an event.

In addition, the Select View Television System can also be utilized by sports coaches of professional, high school, and college sports teams as a training tool since they the system would give sport coaches the ability to being able to view, analyze, and critique players who are away from the action on the field. The invention can also be utilized by medical personnel to review from multiple viewpoints a player's actions before, during, and after an injury to determine the event or movement that caused an injury or further exaggerated an existing injury. Security staff at events would be able to utilize the system to determine the source of objects thrown on playing fields, the original location of a fan that has an altercation with a player or another fan during a game or other televised event, and to resolve a myriad of possible security issues that could arise during the course of a special event.

I claim:

1. Select View Television System that offers sports enthusiasts an interactive game-like experience with multiple viewing capabilities as an alternative to the limitations of “standard” television coverage by allowing televised sports and special events to be viewed as if the viewer was actually attending the event.

2. Select View Television System that allows advertisers to expose their products and services by allowing them to post their advertisement as a screen header or footer on a specified camera view.

3. Select View Television System that can be utilized by sports coaches to view, analyze, and critique players who are away from the action on the field.

4. Select View Television System equipped with a remote control that allows the viewer to select their preferred camera view of a televised event.

5. Select View Television System equipped with a remote control that can be hand held, worn on the wrist, mounted, or in any other fashion remotes are commonly operated.

6. Select View Television System equipped with a remote control that is powered by power sources that included but are not limited to a re-chargeable battery, cordless phone technology, infrared, solar power, alkaline batteries, and other means of providing power to operate and recharge the remote control.

7. Select View Television System comprised of a system of at least 2 alternative camera views that would allow the viewer to view televised events as if they were actually in attendance at the event.

8. Select View Television System that allows medical personnel to review from multiple viewpoints a player's actions before, during, and after an injury to more accurately determine the event or movement that caused an injury or made a previous injury flare up again.

9. Select View Television System that allows security staff to determine items including but not limited to the source of objects thrown onto the playing field, the original location of a fan involved in an attack on a player or on other fan during an event as well as other security issues that could take place during the course of a special event.

10. Select View Television Systems that can be combined by the viewer with any recording device to allow the viewer to review an event via any camera view by recording regardless of which camera view is selected. As a result, the same event could be viewed multiple times as if seen for the very first time.

11. Select View Television System that can be utilized with systems including but not limited to analog, digital, satellite, UHF/VHF, infrared, and other broadcasting systems/mediums.

12. Select View Television system equipped with a remote control that is capable of being integrated with an existing video game controller for camera angle selection.

13. Select View Television System that allows virtual viewing of versions of multiple viewing angles of television, video, sports, or sitcoms feeds that can be computer-generated.
